(19) United States
(12) Patent Application Publication
(10) Pub. No.: US 2005/0137364 A1
(43) Pub. Date: Jun. 23, 2005

(54) Condensing mode operation of gas-phase polymerization reactor

(75) Inventors: Ping P. Cai, Hurricane, WV (US); Robert Darrell Olson, Charleston, WV (US); Ronald Steven Eisinger, Charleston, WV (US); Fathi David Hussein, Cross Lanes, WV (US); Robert Olds Hagerty, La Porte, TX (US); Mark Williams Blood, Hurricane, WV (US)

Correspondence Address: Univation Technologies, LLC, Suite 1950, 5555 San Felipe, Houston, TX, 77056, US

(73) Assignee: Univation Technologies, LLC, Houston, TX (US)

(21) Appl. No.: 10/745,456

(22) Filed: Dec. 23, 2003

(51) Int. Cl. C08F 2/00

(52) U.S. Cl. 526/68; 526/901

(57) ABSTRACT

A continuous gas fluidized bed polymerization process for the production of a polymer from a monomer including continuously passing a gaseous stream comprising the monomer through a fluidized bed reactor in the presence of a catalyst under reactive conditions; withdrawing a polymeric product and a stream comprising unreacted monomer gases; cooling said stream comprising unreacted monomer gases to form a mixture comprising a gas phase and a liquid phase and reintroducing said mixture into said reactor with sufficient additional monomer to replace that monomer polymerized and withdrawn as the product, wherein said liquid phase is vaporized, and wherein the stream comprises an induced condensing agent selected from the group consisting of alkanes, cycloalkanes, and mixtures thereof, the induced condensing agent having a normal boiling point less than 25° C.

### FIELD OF THE INVENTION

The present embodiments relate to processes for condensing mode operation of a gas-phase polymerization reactor. More specifically, the present embodiments are directed to the use of low boiling point induced condensing agents or induced condensing agents having low solubilities in a polymer, which allow the introduction of more induced condensing agent into the reactor to promote more heat removal than conventional induced condensing agents.

### BACKGROUND OF THE INVENTION

The condensing mode of operation in gas-phase polymerization reactors significantly increases the production rate or space time yield by providing extra heat-removal capacity through the evaporation of condensates in the cycle gas. Additional condensation is often promoted to extend the utility of condensed mode operation by adding an induced condensing agent (“ICA”) into the reactor. The amount of ICA that can be introduced into the reactor, however, must be kept below the “stickiness limit” beyond which the bed material becomes too sticky to discharge or to maintain a normal fluidization status.

The discovery of the fluidized bed process for the production of polymers provided a means for producing polymers with a reduction in capital investment and a reduction in energy requirements as compared to then conventional processes. The present disclosure provides a means for even greater savings in energy and capital cost by affording a simple and efficient means for obtaining a substantial increase in production rate in a given size reactor.

The primary limitation on increasing the reaction rate in a fluidized bed reactor is the rate at which heat can be removed from the polymerization zone. The most common means of heat removal employed in conventional fluidized bed reactor processes is by compression and cooling of the recycle gas stream at a point external to the reactor. In commercial scale fluidized bed reaction systems for producing polymers such as polyethylene, the amount of fluid which must be circulated to remove the heat of polymerization is usually greater than the amount of fluid required for support of the fluidized bed and for adequate solids mixing in the fluidized bed. The fluid velocity in the reactor is limited to prevent excessive entrainment and carry-over of solids. A constant bed temperature will result if the heat generated by the polymerization reaction (which is proportional to the polymer production rate) is equal to the heat carried away by the fluidizing stream as it passes through the bed, plus any heat removed or lost by other means.

It has long been believed that the recycle gas temperature could not be lowered any further than to a point slightly above the dew point of the recycle gas stream. The dew point is that temperature at which liquid condensate begins to form in the gas stream. Common practice has been to limit the temperature of the recycle stream at the outlet of the cycle heat exchange zone to a temperature at least 3° to 10° C. above its dew point. This assumption was predicated on the belief that the introduction of liquid into a gas phase fluidized bed reactor would inevitably result in plugging of the distribution plate, if one is employed, less-than-adequate fluidization inside the reactor and accumulation of liquid at the bottom of the reactor which would interfere with continuous operation or result in complete reactor shut-down. For products, such as those using hexene as a comonomer, the relatively high dew point of the recycle stream has severely restricted the production rate.

Currently used ICA's do not provide sufficient heat removal from the polymerization zone. Increasing the amount of ICA significantly to provide sufficient heat removal causes the produced polymer to reach the stickiness limit. Once the polymer is at or above the stickiness limit, small polymer pieces stick to each other and may clog the reactor. U.S. Pat. No. 4,469,855 discloses ethylene copolymerization using diluent gas. U.S. Pat. No. 4,543,399 discloses a process for increasing the space time yield of polymer production in a fluidized bed reactor. U.S. Pat. No. 5,733,987 discloses a process for the gas-phase polymerization of ethylene and ethylene mixtures with alpha-olefins (CH₂═CHR). U.S. Pat. No. 5,990,250 discloses a method of bed temperature control. U.S. Pat. No. 6,262,192 discloses a polymerization process for producing polymers in a continuous gas phase fluidized bed reactor. U.S. Pat. No. 6,489,408 discloses a method to polymerize a monomer comprising contacting one or more monomer(s) with a catalyst system in a gas phase reactor having a recycle system.

It is apparent that a need exists for an ICA that provides sufficient heat removal from the polymerization zone, without causing the produced polymer to reach the stickiness limit. The present invention satisfies these requirements.

### SUMMARY

There is disclosed a continuous gas fluidized bed polymerization process for the production of a polymer from a monomer including continuously passing a gaseous stream comprising the monomer through a fluidized bed reactor in the presence of a catalyst under reactive conditions; withdrawing a polymeric product and a stream comprising unreacted monomer gases; cooling said stream comprising unreacted monomer gases to form a mixture comprising a gas phase and a liquid phase and reintroducing said mixture into said reactor with sufficient additional monomer to replace that monomer polymerized and withdrawn as the product, wherein said liquid phase is vaporized, and wherein the stream comprises an induced condensing agent selected from the group consisting of alkanes, cycloalkanes, and mixtures thereof, the induced condensing agent having a normal boiling point less than 25° C.

### BRIEF DESCRIPTION OF THE DRAWINGS

FIG. 1 is a system diagram illustrating a gas-phase polymerization apparatus and process.

### DETAILED DESCRIPTION

Accordingly, a process is provided for increasing the space time yield of polymer production in a fluidized bed reactor employing an exothermic polymerization reaction by cooling the recycle stream to below its dew point and returning the resultant two-phase fluid stream to the reactor to maintain the fluidized bed at a desired temperature above the dew point of the recycle stream. The cooling capacity of the recycle stream is increased due to the increased amount of ICA used, greater temperature differential between the entering recycle stream and the reactor, and/or by the vaporization of the condensed liquids entrained in the recycle stream.

It has been found that the amount of condensation of liquid in the recycle stream can be maintained at up to 50 percent by weight, for example. This degree of condensation is achieved by maintaining the outlet temperature from the cycle heat exchange zone so as to effect the required degree of cooling below the dew point of the mixture.

The space time yield improvements achieved are the result of the increased amount of ICA used and/or the increased cooling capacity of the recycle stream. This increased capacity is due both to the greater temperature differential between the entering recycle stream and the bed temperature and to the evaporation of condensed liquid entrained in the recycle stream.

It will be appreciated that increased cooling is achieved not only by evaporation of entering entrained liquid, but also by the overall reduction in the temperature of both the gas and liquid phases of the recycle stream in comparison to previously known methods of operation of fluidized bed reactor systems.

It will be understood by those of ordinary skill in the art that ICAs with low solubilities in polymer resin will optimize the relationship between the tendency to promote stickiness and the ability to remove heat, allowing increased production rates in the reactor. This relationship is a trade-off between limiting the stickiness of the produced resin and the heat removal capability. With a relatively high total solubility of ICA(s), and comonomer(s), and other components in the gaseous stream dissolved into the resin, the resin becomes sticky. Above a certain “stickiness limit” or total solubility in the resin, agglomerates form at different parts of the reactor, causing sheeting on interior wall of the reactor and/or recycle system, chunks and/or plate pluggage. On the other hand, the heat removal capability generally increases as the proportion of ICA in the fluidizing gas increases.

ICAs with low normal boiling points can reduce resin stickiness because of their low solubilities in the resin. Therefore, those ICAs can increase heat-removal capacity because more ICAs can be fed into the bed without raising resin stickiness to an unacceptable level. There are disclosed ICAs which can increase heat-removal capacity, the ICAs having low normal boiling points, and there are disclosed ICAs which can increase heat-removal capacity, the ICAs having low solubility in a polymer.

Although not limited to any specific type of polymerization reaction, the following discussions of the operation of the apparatus, process and method may be directed to polymerizations of olefin-type monomers where the present embodiments have been found to be especially advantageous.

In very general terms, a conventional fluidized bed process for producing resins, particularly polymers produced from monomers, is practiced by passing a gaseous stream containing one or more monomers continuously through a fluidized bed reactor under reactive conditions and in the presence of a catalyst. The gaseous stream containing unreacted gaseous monomer is withdrawn from the reactor continuously, compressed, cooled and recycled into the reactor. Product is withdrawn from the reactor. Make-up monomer is added to the recycle stream.

The polymer-forming reaction is exothermic, making it necessary to maintain in some fashion the temperature of the gas stream inside the reactor at a temperature not only below the resin and catalyst degradation temperatures, but at a temperature below the fusion, softening or sticking temperature of resin particles produced during the polymerization reaction. This is necessary to prevent plugging of the reactor due to rapid growth of polymer chunks which cannot be removed in a continuous fashion as product. It will be understood, therefore, that the amount of polymer that can be produced in a fluidized bed reactor of a given size in a specified time period is directly related to the amount of heat which can be withdrawn from the fluidized bed.

Accordingly, the recycle gas stream is intentionally cooled to a temperature below the dew point of the recycle gas stream to produce a two-phase fluid gas-liquid mixture, which also carries some particles, under conditions such that the liquid phase of the mixture will remain entrained in the gas phase of the mixture at least from the point of entry into the fluidized bed reactor. A substantial increase in space time yield results from this practice with little or no change in product properties or quality. When practiced as described herein, the overall process proceeds continuously and smoothly and without unusual operational difficulties.

In one embodiment, a limitation on the extent to which the recycle gas stream can be cooled below the dew point is that the gas-to-liquid ratio be maintained at a level sufficient to keep the liquid phase of the two-phase fluid mixture in an entrained or suspended condition until the liquid is vaporized. It is also necessary that the velocity of the upwardly flowing fluid stream be sufficient to maintain the fluidized bed in a suspended condition.

In general, it would be desirable to have a high proportion of the induced condensing agent (“ICA”) in the gaseous stream, to enhance the heat-removal from the reactor. Within the polymer particles, there is dissolved ICA, comonomer(s), other hydrocarbon(s), and even monomer(s), with quantities depending on the types those species and the gas composition. Usually the amount of ICA in the fluidizing gas is one of the most important factors that affect the overall quantity of the dissolved species in the polymer. At certain levels of ICA, an excess amount of the ICA is dissolved into the polymer produced, making the polymer sticky. Therefore, the amount of the ICA that can be introduced into the reactor, must be kept below the “stickiness limit” beyond which the bed material becomes too sticky to discharge or to maintain a normal fluidization status. Each ICA has a different solubility in each specific polymer product, and in general, it is desirable to utilize an ICA having relatively low solubility in the produced polymer, so that more of the ICA can be utilized in the gaseous stream before reaching the stickiness limit.

The entry point for the two-phase fluid recycle stream may be below the fluidized bed (polymerization zone) in a gas-phase reactor to ensure uniformity of the upwardly flowing gas stream and to maintain the bed in a suspended condition. The recycle stream containing entrained liquid is introduced into the reactor at a point in the lower region of the reactor, and optionally at the very bottom of the reactor to ensure uniformity of the fluid stream passing upwardly through the fluidized bed. Sometimes, the recycle stream or fractions of the stream can also be fed into one, or more than one, locations in the reactor's dense fluidized bed.

A baffle or similar means for preventing regions of low gas velocity in the vicinity of the recycle stream entry point may be provided to keep solids and liquids entrained in the upwardly flowing recycle stream.

The gas stream may flow in a manner such that there are no dead spaces in the bed where unremovable solids can form.

The disclosed methods can be practiced in connection with any exothermic polymerization process carried out in a gas phase fluidized bed.

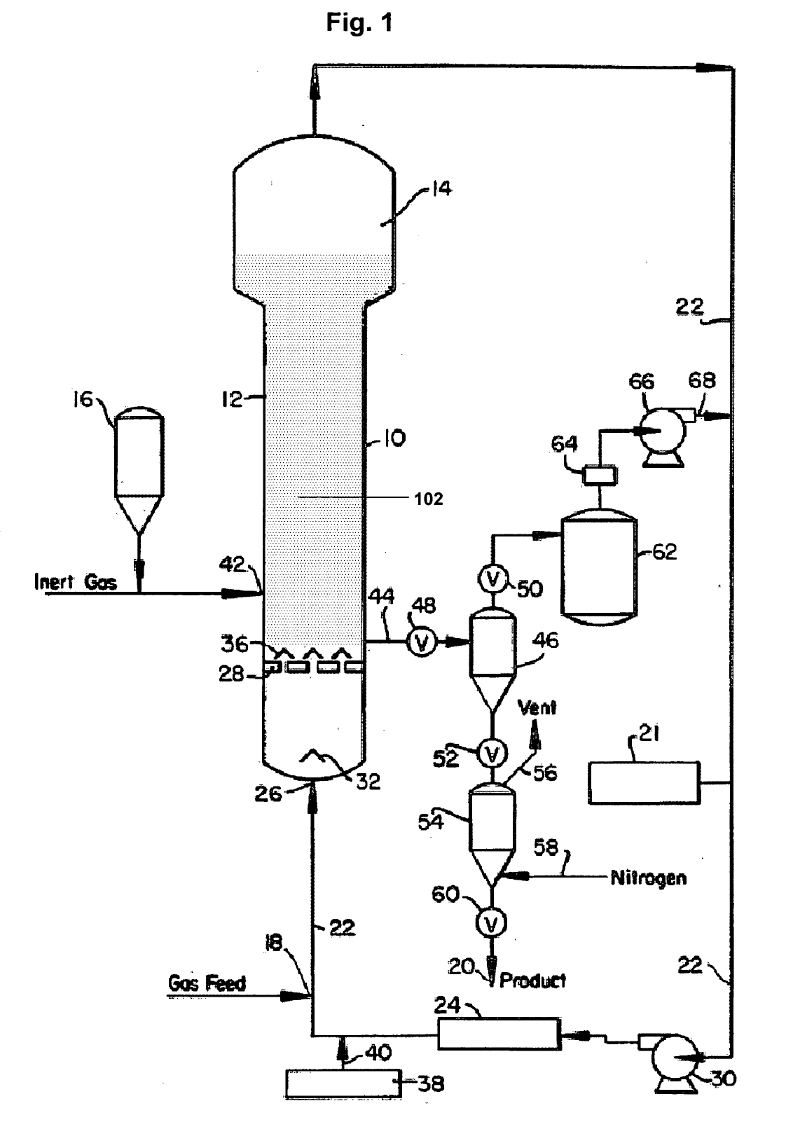

A fluidized bed reaction system which is suitable for production of polyolefin resin is illustrated in FIG. 1. With reference thereto, reactor 10 consists of reaction zone 12 and velocity reduction zone 14.

In general, the height to diameter ratio of the reaction zone can vary in the range of 2:1 to 10:1. The range can vary to larger or smaller ratios and depends upon the desired production capacity. The cross-sectional area of velocity reduction zone 14 is typically within the range of 1.0 to 3.0 multiplied by the cross-sectional area of reaction zone 12.

Reaction zone 12 includes bed 102 of growing polymer particles, formed polymer particles and a minor amount of catalyst particles fluidized by the continuous flow of polymerizable and modifying gaseous components in the form of make-up feed and recycle fluid through the reaction zone. To maintain a viable fluidized bed, the superficial gas velocity through the bed must exceed the minimum fluidization velocity, and may be at least 0.2 ft/sec (0.061 m/sec) above minimum fluidization velocity. Ordinarily, the superficial gas velocity does not exceed 5.0 ft/sec (1.52 m/sec), and usually no more than 3.2 ft/sec (0.98 m/sec) is sufficient.

Dense fluidized bed 102 usually contains well mixed particles to prevent the formation of localized “hot spots” and to entrap and distribute the particulate catalyst throughout the reaction zone. On start up, the reactor may be charged with a base of particulate polymer particles, also called a seed bed, before gas flow is initiated. Such particles may be identical in nature to the polymer to be formed or different therefrom. When different, they are withdrawn with the desired formed polymer particles as the first product. Eventually, a fluidized bed of desired polymer particles supplants the start-up bed.

The partially or totally activated precursor composition and/or catalyst used in the fluidized bed can be fed into the reactor in the form of solid particles, slurry, liquid, etc. For example, the solid catalyst may be stored for service in reservoir 16 under a blanket of a gas which is inert to the stored material, such as nitrogen or argon. Suitable catalysts for polymerization are known in the art, and include catalysts commercially available from Univation Technologies, ExxonMobil Chemicals, and The Dow Chemical Company.

Fluidization is achieved by a high rate of fluid recycle to and through the bed, typically on the order of 50 times the rate of feed of make-up fluid. Fluidized bed 102 has the general appearance of a dense mass of individually moving particles as created by the percolation of gas through the bed. The pressure drop through the bed is equal to or slightly greater than the weight of the bed divided by the cross-sectional area. It is thus dependent on the geometry of the reactor.

Make-up fluid is usually fed to recycle line 22, for example, at point 18. The composition of the make-up stream is determined by gas analyzer 21. Gas analyzer 21 determines the composition of the recycle stream and the composition of the make-up stream is adjusted accordingly to maintain an essentially steady state gaseous composition within the reaction zone.

Gas analyzer 21 may be a conventional commercially available gas analyzer which operates in a conventional manner to indicate recycle stream composition and which is adapted to regulate the feed. Generally, gas analyzer 21 can be positioned so as to receive the recycle stream gas from a point between velocity reduction zone 14 and heat exchanger 24.

To ensure complete fluidization, the two-phase fluid recycle stream and, where desired, part of the make-up stream are returned through recycle line 22 to reactor 10 at point 26 below the dense fluidized bed 102. Gas distributor plate 28 is provided above point 26 to aid in fluidizing bed 102. In passing through the fluidized bed 102, the two-phase fluid recycle stream absorbs the heat of reaction generated by the polymerization reaction. The absorption of reaction heat results in the temperature raise of the two-phase fluid recycle stream and the vaporization of the liquid portions of the two-phase fluid recycle stream.

The portion of the fluidizing stream which does not react in the bed constitutes the recycle stream which is removed from the polymerization zone, preferably by passing it into velocity reduction zone 14 above the reaction zone 12, where entrained particles are given an opportunity to drop back into the dense fluidized bed.

The recycle stream is then compressed in compressor 30 and then passed through a heat exchange zone wherein the heat of reaction is removed before it is returned to the reactor 10. The heat exchange zone may be heat exchanger 24, which can be of the horizontal or vertical type. The recycle stream is then returned to reactor 10 at its base 26 and to fluidize the bed of polymer particles through gas distributor plate 28. Gas deflector 32, or other types of structures such as those disclosed by U.S. Pat. No. 4,933,149, and U.S. Pat. No. 4,877,587, is installed at the inlet to the reactor to prevent contained polymer particles from settling out and agglomerating into a solid mass, and prevent liquid from accumulating within the space under the distributor plate.

Heat exchanger 24 cools the recycle stream to a temperature below the dew point of the recycle stream, so that the gaseous recycle stream that enters heat exchanger 24 is converted into a two-phase fluid recycle stream.

The temperature of the bed is controlled at an essentially constant temperature under steady state conditions by constantly removing the heat of reaction. A temperature gradient may exist in the bottom of the dense fluidized bed in a layer, for example of 3 to 24 inches (7.6 to 61 cm), between the temperature of the inlet fluid and the temperature of the remainder of the bed 102.

Good gas distribution plays an important role in the operation of reactor 10. Fluidized bed 102 contains growing and formed particulate polymer particles, as well as catalyst particles. Because the polymer particles are hot and possibly active, they must be prevented from settling, for if a quiescent mass is allowed to exist, any active catalyst contained therein may continue to react and cause fusion. Uniformly distributing the recycle fluid through the bed at a rate sufficient to maintain fluidization through the bed is, therefore, important.

Gas distribution plate 28 is one way of achieving good gas distribution and may be a screen, slotted plate, perforated plate, a plate of the bubble-cap type, or other conventional and commercially available plates or other types of gas distribution devices. Whatever its design, plate 28 distributes the two-phase fluid recycle stream at the bottom of the dense fluidized bed to keep bed in a fluidized condition, and also serves to support a quiescent bed of resin particles when reactor 10 is not in operation.

A commonly used type of distributor in polymerization reactors is the perforated plate with some above-hole structure on top of each hole, to prevent particle sifting. For example, over each of the holes of plate 28 there are positioned triangular angle irons 36 which are fixedly mounted to plate 28. Angle irons 36 serve to distribute the flow of fluid along the surface of the plate so as to avoid stagnant zones of solids. In addition they prevent the resin from flowing through the holes when the bed is settled.

The solubility of a specific hydrocarbon in a polymer material is determined by the temperature, partial pressure of the hydrocarbon and type of polymer. The normal boiling point of a hydrocarbon (i.e., the boiling point under the ambient or atmospheric pressure) is a good indication of its solubility in polymer materials. In general, low molecular weight hydrocarbons, with relatively low boiling points, have relatively low solubilities, and high molecular weight hydrocarbons, with relatively high boiling points, have relatively high solubilities. The normal boiling point is generally an accurate indicator of solubility. The normal boiling point of a hydrocarbon may be employed to estimate its solubility in polymer, although the result could be strongly polymer product dependent.

As discussed above, fluids inert to the catalyst and reactants are also present in the two-phase fluid recycle stream. Suitable inert fluids include induced condensing agents (ICA), for example, alkanes and cycloalkanes. Suitable ICAs are materials having a low normal boiling point and/or a low solubility in polymers, for example with a normal boiling point less than 25° C. In another embodiment, suitable ICAs have a normal boiling point less than 20° C. In another embodiment, suitable ICAs have a normal boiling point less than 15° C. In another embodiment, suitable ICAs have a normal boiling point less than 10° C. In another embodiment, suitable ICAs have a normal boiling point less than 0° C.

Properties of some ICAs are shown in the attached Table 1.

TABLE 1

| | Typical | | | |
|---|---|---|---|---|
| | Solubility in | | | |
| | Polyethylene* | | Normal | Heat of |
| | (kg ICA/100 kg | Molecular | Boiling Point | Vaporization |
| ICA | polymer) | Weight | (° C.) | (kJ/Mol) |
| cyclohexane | 38.3 | 84.2 | 80.7 | 29.9 |
| n-hexane | 28.5 | 86.2 | 68.7 | 28.8 |
| iso-hexane (2- | 21.6 | 86.2 | 60.3 | 27.9 |
| methylpentane) | | | | |
| neo-hexane | 12.9 | 86.2 | 49.7 | 26.4 |
| (2,2-dimethyl- | | | | |
| butane) | | | | |
| cyclopentane | 2.15 | 70.1 | 49.2 | 27.2 |
| n-pentane | 1.83 | 72.1 | 36.1 | 25.8 |
| iso-pentane (2- | 1.63 | 72.1 | 27.8 | 24.8 |
| methylbutane) | | | | |
| cyclobutane | 1.26 | 56.1 | 12.5 | 24.0 |
| neo-pentane | 1.18 | 72.1 | 9.49 | 22.7 |
| (2,2-dimethyl- | | | | |
| propane) | | | | |
| n-butane | 0.94 | 58.1 | −0.6 | 22.4 |
| iso-butane (2- | 0.77 | 58.1 | −11.7 | 21.4 |
| methylpropane) | | | | |
| cyclopropane | 0.44 | 42.1 | −32.8 | 19.9 |
| propane | 0.29 | 44.0 | −42.1 | 18.7 |

*determined under 90° C. reactor temperature and ICA partial pressure of 25 psi (1.72 × 10⁵ Pa), for polyethylene with melt index = 1.0 (decigrams/1 minute) and resin density = 918 (kg/m³). Melt index determined using ASTM D1238.

In one embodiment, suitable ICAs include ICAs having a typical solubility* less than 1.5. In another embodiment, suitable ICAs include ICAs having a typical solubility* less than 1.25. In another embodiment, suitable ICAs include ICAs having a typical solubility* less than 1.0. In another embodiment, suitable ICAs include ICAs having a typical solubility* less than 0.8. In another embodiment, suitable ICAs include ICAs having a typical solubility* less than 0.5. In another embodiment, suitable ICAs include ICAs having a typical solubility* less than 0.3. In these embodiments, the typical solubility is determined under 90° C. reactor temperature and ICA partial pressure of 25 psi (1.72×10⁵ Pa), for polyethylene with melt index=1.0 (dg/min) and resin density=918 (kg/m³). In these embodiments, the melt index is determined using ASTM D1238.

In another embodiment, suitable ICAs include cyclobutane, neopentane, n-butane, isobutane, cyclopropane, propane, and mixtures thereof.

In another embodiment, a suitable two-phase fluid recycle stream composition (mol %) includes at least 10% n-butane and/or iso-butane.

In another embodiment, a suitable two-phase fluid recycle stream composition (mol %) includes at least 15% n-butane and/or iso-butane.

In another embodiment, a suitable two-phase fluid recycle stream composition (mol %) includes at least 20% n-butane and/or iso-butane.

In another embodiment, a suitable two-phase fluid recycle stream composition (mol %) includes at least 25% cyclobutane, n-butane and/or iso-butane.

In another embodiment, a suitable two-phase fluid recycle stream composition (mol %) includes at least 10% propane.

In another embodiment, a suitable two-phase fluid recycle stream composition (mol %) includes at least 20% propane.

In another embodiment, a suitable two-phase fluid recycle stream composition (mol %) includes at least 30% propane.

In another embodiment, a suitable two-phase fluid recycle stream composition (mol %) includes at least 40% propane.

In another embodiment, a suitable two-phase fluid recycle stream composition (mol %) includes at least 45% propane.

An activator compound, if utilized, may be added to the reaction system downstream from heat exchanger 24. For instance, the activator may be fed into the recycle system from dispenser 38 through line 40.

It is essential to operate the fluidized-bed reactor at a temperature below the sintering temperature of the polymer particles to ensure that sintering will not occur. The sintering temperature is mainly a function of resin density. In general, low-density polyethylene resins, for example, have a low sintering temperature and high-density polyethylene resins, for example, have a higher sintering temperature. For example, temperatures of from 75° C. to 95° C. are used to prepare ethylene copolymers having a density of from 0.91 g/cm³ to 0.95 g/cm³, while temperatures of from 100° C. to 115° C. are used to prepare ethylene copolymers or homopolymers having a density of from 0.95 g/cm³ to 0.97 g/cm³.

The fluidized-bed reactor may be operated at pressures of up to 1000 psi (6.8948×10⁶ Pa), and is for polyolefin resin production preferably operated at a pressure of from 100 psi to 500 psi (6.8948×10⁵ Pa-3.4474×10⁶ Pa), for example 300 psi to 400 psi (2.068-2.758×10⁶ Pa), with operation at the higher pressures in such ranges generally favoring heat transfer since an increase in pressure increases the unit volume heat capacity of the gas.

The partially or totally activated precursor composition and/or catalyst (hereinafter collectively referred to as catalyst) is injected into the bed at a rate equal to its consumption, for example, at point 42 which is above distributor plate 28. The catalyst is injected at one or more than one points in the dense fluidized bed 102 where good mixing of polymer particles occurs. Injecting the catalyst at a point above distribution plate 28 is an important feature for satisfactory operation of a fluidized bed polymerization reactor. Since catalysts are highly active, injection of the catalyst into the area below distributor plate 28 may cause polymerization to begin there and eventually cause plugging of distributor plate 28. Injection into the dense fluidized bed 102, instead, aids in distributing the catalyst throughout the fluidized bed 102 and tends to preclude the formation of localized spots of high catalyst concentration which may result in the formation of “hot spots.” Injection of the catalyst into reactor 10 above the dense fluidized bed may result in excessive catalyst carryover into the recycle line where polymerization may begin and plugging of the line and heat exchanger may eventually occur.

The catalyst can be injected into reactor 10 by various techniques that are commonly known in the art.

A gas which is inert to the catalyst, such as nitrogen, argon or a low molecular weight alkane, may be used to carry the catalyst into the fluidized bed 102.

The rate of polymer production in the reactor depends on the rate of catalyst injection and the concentration of monomer(s) in the recycle stream. The production rate may be conveniently controlled by simply adjusting the rate of catalyst injection, or alternatively, by adjusting the concentration of monomers in the recycle stream.

Since any change in the rate of catalyst injection will change the reaction rate and hence rate of generation of the heat of reaction, the temperature of the recycle stream entering the reactor is adjusted upwards and downwards to accommodate any change in the rate of heat generation. This ensures the maintenance of an essentially constant temperature in the bed. Complete instrumentation of both fluidized bed reactor and the recycle stream cooling system is, of course, useful to detect any temperature change in the fluidized bed 102 so as to enable either the operator or a conventional automatic control system to make a suitable adjustment in the temperature of the recycle stream.

Under a given set of operating conditions, fluidized bed 102 is maintained at essentially a constant height by withdrawing a portion of the bed as product at the rate of formation of the particulate polymer product. Since the rate of heat generation is directly related to the rate of product formation, a measurement of the temperature rise of the fluid across the reactor (the difference between inlet fluid temperature and exit fluid temperature) added to the heat of vaporization for the fluids that were vaporized within reactor 10, is indicative of the rate of particulate polymer formation at a constant fluid velocity.

On discharge of particulate polymer product from reactor 10, it is desirable and preferable to separate fluid from the product and to return the fluid to recycle line 22, or directly to the reactor. There are numerous ways known to the art to accomplish this. One system is shown in FIG. 1.

Specifically, fluid and product leave reactor 10 at point 44 and enter product discharge tank 46 through valve 48 which is designed to have minimum restriction to flow when opened, such as a ball valve. Positioned above and below product discharge tank 46 are conventional valves 50, 52, with the latter being adapted to provide passage of product into product surge tank 54. Product surge tank 54 has venting means illustrated by line 56 and gas entry means illustrated by line 58. Also positioned at the base of product surge tank 54, is discharge valve 60 which when in the open position discharges product for conveying to storage. Valve 50 when in the open position releases fluid and/or gas to surge tank 62. Fluid from surge tank 62 is directed through filter absorber 64 and thence through compressor 66 and into recycle line 22 through line 68.

In a operation, valve 48 is open and valves 50, 52 are in a closed position. Product and fluid enter product discharge tank 46. Valve 48 closes and the product is allowed to settle in product discharge tank 46. Valve 50 is then opened permitting fluid to flow from product discharge tank 46 to surge tank 62 from which it is continually compressed back into recycle line 22. Valve 50 is then closed and valve 52 is opened and any product in product discharge tank 46 flows into product surge tank 54. Valve 52 is then closed. The product is purged with inert gas, for example nitrogen, which enters product surge tank 54 through line 58 and is vented through line 56. Product is then discharged from product surge tank 54 through valve 60 and conveyed through line 20 to storage or other downstream equipment, such as pelleter.

The particular timing sequence of the valves is accomplished by the use of conventional programmable controllers which are well known in the art. Moreover, the valves can be kept substantially free of agglomerated particles by installation of provisions for directing a stream of gas periodically through the valves and back to the reactor.

Fluidized-bed reactor 10 is equipped with an adequate venting system (not shown) to allow venting the bed during start up and shut down. Reactor 10 does not require the use of stirring and/or wall scraping. Recycle line 22 and the elements therein (compressor 30, heat exchanger 24) may be smooth surfaced and devoid of unnecessary obstructions so as not to impede the flow of recycle fluid or entrained particles.

Among the polymers which may be produced in the process of the present invention are homopolymers of ethylene, propylene, and/or butene, or copolymers of a major mole percent of ethylene, propylene and/or butene and a minor mole percent of one or more C₂ to C₈ alpha-olefins, for example, ethylene, propylene, butene-1, pentene-1, hexene-1, 4-methylpentene-1 and octene-1.

In one embodiment, when made in the fluid-bed process described herein, ethylene polymers are granular materials which have a settled bulk density of 15 to 33 pounds per cubic foot (240.8-529.7 kg/m³) and an average particle size of the order of 0.005 to 0.1 inches (0.0127-0.254 cm). Particle size is important for the purposes of readily fluidizing the polymer particles in the fluid-bed reactor, as herein described.

Raising reactor pressure permits a relatively larger amount of low solubility ICAs be condensed in the stream and recycled back to the reactor, and hence increases the production rate. For example, raising the reactor pressure from 350 psi to 400 psi (2.413 to 2.758×10⁶ Pa), usually further increases the heat removal capability of the recycle gas stream significantly, when using the low solubility ICAs.

Some commonly utilized ICAs, for example n-hexane, have a relatively high solubility in the produced resins, which limits the amount of ICAs which can be used because of the stickiness concern. Low boiling point ICAs with solubility less than that of commonly used ICAs reduce the stickiness of the resin, and increase the “stickiness limit” to allow more ICA in the system. Thus, an increase of reactor production can be achieved because of increased heat removal capacity.

In one embodiment, a suitable ICA and pressure combination is n-butane at 400 psig.

In another embodiment, certain resin products were found to benefit more from the use of a low solubility ICA. The production of those products are often restricted by the stickiness limit with the commonly used ICAs, such as the linear low density polyethylene (LLDPE) hexene copolymers made by Ziegler-Natta catalyst. A relatively high comonmer level in the fluidizing gas, and the “stickiness-sensitive” resin property substantially limited the usage of those “commonly utilized” ICAs. Switching to a low solubility ICA, for this case, may significantly increase the production rate.

In one embodiment, stickiness is generally considered to be a function of the total solubility of all the solutes (for example, monomers, comonomers, ICAs and other saturated hydrocarbons in the fluidizing gas) within the resin, for example polyethylene. In general, the stickiness limit is reached for polyethylene, as the total solubility of all the solutes approaches a given limit which depends on product type, reactor condition and solutes' partial pressures. Operating a reactor below the stickiness limit, with the use of low-solubility ICA allows substantially more ICA and more condensation in the recycle stream. Therefore, the production rate of the same reactor may be significantly increased.

### EXAMPLES

All the following examples are related to commercial scale operations conducted in a gas phase fluidized bed polymerization reactor similar to the one as shown and described above in FIG. 1. The reactor used for these examples have a diameter of 14.5 feet (4.42 m). Detailed operating conditions and operation results of these examples are listed in Table 2.

Examples 1, 4 and 6 are comparative examples using iso-pentane as ICA, running at conditions very close to their stickiness limits. Therefore, the production rates are the maximum ones can be achieved under those conditions.

Examples 2, 3, 5 and 7 employ low-solubility ICAs. It can be seen from Table 2 that significant increase of production rate is achieved, although they are not necessarily operated near the stickiness limits.

TABLE 2

| | Example | | | | | | |
|---|---|---|---|---|---|---|---|
| | 1 | 2 | 3 | 4 | 5 | 6 | 7 |
| Product | LLDPE | LLDPE | LLDPE | LLDPE | LLDPE | HDPE | HDPE |
| Comonomer | 1-butene | 1-butene | 1-butene | 1-hexexe | 1-hexexe | 1-hexexe | 1-hexexe |
| Catalyst | Ziegler- | Ziegler- | Ziegler- | Metallocene | Metallocene | Ziegler- | Ziegler- |
| | Natta | Natta | Natta | (Zr | (Zr based) | Natta | Natta |
| | | | | based) | | | |
| Resin Density | 0.918 | 0.918 | 0.918 | 0.918 | 0.918 | 0.954 | 0.954 |
| (g/cc) | | | | | | | |
| Melt index (dg/min)**** | 1.0 | 1.0 | 1.0 | 1.0 | 1.0 | 40 | 40 |
| Induced | Iso- | n-butane | Iso-butane | Iso- | n-butane | Iso- | propane |
| Condensing | pentane | | | pentane | | petane | |
| Agent | | | | | | | |
| Reactor Pressure | 350 | 350 | 350 | 350 | 350 | 350 | 400 |
| (psig) | | | | | | | |
| Reactor | 91 | 91 | 91 | 85 | 85 | 108 | 108 |
| Temperature | | | | | | | |
| (° C.) | | | | | | | |

Gas Composition (mol %)

| | | | | | | | |
|---|---|---|---|---|---|---|---|
| Ethylene | 24.68 | 24.68 | 24.68 | 57.58 | 57.58 | 38.39 | 33.76 |
| propylene | 0.00 | 0.00 | 0.00 | 0.00 | 0.00 | 0.00 | 0.00 |
| 1-butene | 7.81 | 7.81 | 7.81 | 0.00 | 0.00 | 0.00 | 0.00 |
| 1-hexene | 0.0 | 0.00 | 0.00 | 0.98 | 0.98 | 1.11 | 0.98 |
| Hydrogen | 2.44 | 2.44 | 2.44 | 0.01 | 0.01 | 18.39 | 16.18 |
| Ethane | 5.21 | 4.06 | 3.46 | 2.00 | 0.36 | 6.53 | 0.000 |
| Propane | 0.00 | 0.00 | 0.00 | 0.00 | 0.00 | 0.00 | 47.48 |
| N-butane | 4.02 | 26.08 | 4.02 | 0.00 | 37.1 | 0.00 | 0.00 |
| N-hexane | 0.00 | 0.00 | 0.00 | 0.10 | 0.10 | 1.83 | 1.61 |
| Iso-petane | 11.38 | 0.00 | 0.00 | 18.10 | 0.00 | 10.81 | 0.00 |
| Iso-butane | 0.29 | 0.29 | 27.90 | 0.00 | 0.00 | 0.00 | 0.00 |
| Iso- & cis- | 1.05 | 1.05 | 1.05 | 0.00 | 0.00 | 0.00 | 0.00 |
| butene | | | | | | | |
| Methane | 0.05 | 0.04 | 0.03 | 0.00 | 0.00 | 0.28 | 0.00 |
| Nitrogen | 43.07 | 33.55 | 28.62 | 21.23 | 3.86 | 22.66 | 0.00 |
| Superficial Gas | 2.4 | 2.4 | 2.4 | 2.4 | 2.4 | 2.4 | 2.4 |
| Velocity (ft/s) | | | | | | | |
| Dew Point (° C.) | 65.8 | 63.3 | 70.2 | 74.9 | 75 | 72.3 | 62.3 |
| Weight % of | 20 | 26.2 | 37.9 | 23.2 | 40.9 | 20.6 | 18.1 |
| Condensing | | | | | | | |
| Cycle Gas Inlet | 47.3 | 47.3 | 47.3 | 50.5 | 50.5 | 44.6 | 44.6 |
| Temperature to | | | | | | | |
| the Reactor (° C.) | | | | | | | |
| Enthalpy at Inlet | 3510.4 | 3279.1 | 2762.1 | 3161.9 | 2381.4 | 3398.6 | 3506.2 |
| Temperature | | | | | | | |
| (btu/lbmol) | | | | | | | |
| Enthalpy at | 5565.7 | 5822.9 | 6000.4 | 5144.1 | 5508.6 | 5752.4 | 6292.2 |
| Reactor | | | | | | | |
| Temperature | | | | | | | |
| (btu/lbmol) | | | | | | | |
| Induced | Iso- | n-butane | Iso-butane | Iso- | n-butane | Iso- | propane |
| Condensing | pentane | | | pentane | | petane | |
| Agent | | | | | | | |
| Relative | 100.0% | 127.6%* | 166.7%* | 100.0% | 172.3%** | 100.0% | 126.7%*** |
| Production Rate | | | | | | | |

*relative to Example #1
**relative to Example #4
***relative to Example #6
****determined using ASTM D1238

In one preferred embodiment, n-butane is used as an ICA to produce metallocene catalyzed linear low density polyethylene in a reactor at 350 psig and 85° C., as more fully set forth in Example 5 above. In another preferred embodiment, iso-butane is used as an ICA to produce Ziegler-Natta catalyzed linear low density polyethylene in a reactor at 350 psig and 91° C., as more fully set forth in Example 3 above.

Although illustrative embodiments have been shown and described, a wide range of modification, changes and substitution is contemplated in the foregoing disclosure. In some instances, some aspects of the illustrative embodiments may be employed without a corresponding use of the other aspects. Accordingly, it is appropriate that the appended claims be construed broadly and in a manner consistent with the scope of the invention.

Unless otherwise indicated, all numbers expressing quantities of ingredients, properties, reaction conditions, and so forth, used in the specification and claims are to be understood as approximations based on the desired properties sought to be obtained by the present invention, and the error of measurement, etc., and should at least be construed in light of the number of reported significant digits and by applying ordinary rounding techniques. Notwithstanding that the numerical ranges and values setting forth the broad scope of the invention are approximations, the numerical values set forth are reported as precisely as possible.

1. A continuous gas fluidized bed polymerization process for the production of a polymer from a monomer comprising:
continuously passing a gaseous stream comprising the monomer through a fluidized bed reactor in the presence of a catalyst under reactive conditions;
withdrawing a polymeric product and a stream comprising unreacted monomer gases;
cooling said stream comprising unreacted monomer gases to form a mixture comprising a gas phase and a liquid phase and reintroducing said mixture into said reactor with sufficient additional monomer to replace that monomer polymerized and withdrawn as the product,
wherein said liquid phase is vaporized, and wherein the stream comprises an induced condensing agent selected from the group consisting of alkanes, cycloalkanes, and mixtures thereof, the induced condensing agent having a normal boiling point less than 25° C.

2. The continuous gas fluidized bed polymerization process of claim 1, wherein the stream comprises n-butane.

3. The continuous gas fluidized bed polymerization process of claim 1, wherein the stream comprises iso-butane.

4. The continuous gas fluidized bed polymerization process of claim 1, wherein the stream comprises propane.

5. The continuous gas fluidized bed polymerization process of claim 1, wherein the stream comprises at least one of cyclopropane and cyclobutane.

6. The continuous gas fluidized bed polymerization process of claim 1, wherein the fluidized bed reactor is run at a pressure of at least 300 psig.

7. The continuous gas fluidized bed polymerization process of claim 1, wherein the fluidized bed reactor is run at a pressure of at least 350 psig.

8. The continuous gas fluidized bed polymerization process of claim 1, wherein the fluidized bed reactor is run at a pressure of at least 400 psig.

9. The continuous gas fluidized bed polymerization process of claim 1, wherein the induced condensing agent has a normal boiling point less than 20° C.

10. The continuous gas fluidized bed polymerization process of claim 1, wherein the induced condensing agent has a normal boiling point less than 10° C.

11. The continuous gas fluidized bed polymerization process of claim 1, wherein the induced condensing agent has a normal boiling point less than 0° C.

12. The continuous gas fluidized bed polymerization process of claim 1, wherein the induced condensing agent has a solubility of less than 1.5 kilograms of induced condensing agent per 100 kg of a polyethylene in a reactor having a temperature of 90° C. and an induced condensing agent partial pressure of 25 psi, the polyethylene having a melt index of 1.0 dg/1 minute and a resin density of 918 kg/meter³.

13. The continuous gas fluidized bed polymerization process of claim 1, wherein the induced condensing agent has a solubility of less than 1.25 kilograms of induced condensing agent per 100 kg of a polyethylene in a reactor having a temperature of 90° C. and an induced condensing agent partial pressure of 25 psi, the polyethylene having a melt index of 1.0 dg/1 minute and a resin density of 918 kg/meter³.

14. The continuous gas fluidized bed polymerization process of claim 1, wherein the induced condensing agent has a solubility of less than 1.0 kilograms of induced condensing agent per 100 kg of a polyethylene in a reactor having a temperature of 90° C. and an induced condensing agent partial pressure of 25 psi, the polyethylene having a melt index of 1.0 dg/1 minute and a resin density of 918 kg/meter³.

15. The continuous gas fluidized bed polymerization process of claim 1, wherein the induced condensing agent has a solubility of less than 0.8 kilograms of induced condensing agent per 100 kg of a polyethylene in a reactor having a temperature of 90° C. and an induced condensing agent partial pressure of 25 psi, the polyethylene having a melt index of 1.0 dg/1 minute and a resin density of 918 kg/meter³.

16. The continuous gas fluidized bed polymerization process of claim 1, wherein the induced condensing agent has a solubility of less than 0.5 kilograms of induced condensing agent per 100 kg of a polyethylene in a reactor having a temperature of 90° C. and an induced condensing agent partial pressure of 25 psi, the polyethylene having a melt index of 1.0 dg/1 minute and a resin density of 918 kg/meter³.

17. The continuous gas fluidized bed polymerization process of claim 1, wherein the induced condensing agent has a solubility of less than 0.4 kilograms of induced condensing agent per 100 kg of a polyethylene in a reactor having a temperature of 90° C. and an induced condensing agent partial pressure of 25 psi, the polyethylene having a melt index of 1.0 dg/1 minute and a resin density of 918 kg/meter³.

18. The continuous gas fluidized bed polymerization process of claim 1, wherein the induced condensing agent has a solubility of less than 0.3 kilograms of induced condensing agent per 100 kg of a polyethylene in a reactor having a temperature of 90° C. and an induced condensing agent partial pressure of 25 psi, the polyethylene having a melt index of 1.0 dg/1 minute and a resin density of 918 kg/meter³.

19. A method for controlling the temperature of a gas fluidized bed during the production of polymer in a fluidized bed reactor by an exothermic polymerization reaction, which comprises continuously introducing into the bed a stream comprising unreacted monomer gas and liquid cooled to below the maximum desired temperature within said bed, wherein said liquid is vaporized, wherein said liquid contains at least one material selected from the group consisting of alkanes, cycloalkanes, and mixtures thereof, the liquid having a normal boiling point less than 25° C.

20. A process for producing polymer from monomer by an exothermic polymerization reaction in a gas fluidized bed reactor which comprises:
(1) continuously passing a gaseous stream comprising at least one monomer and a material selected from the group consisting of alkanes, cycloalkanes, and mixtures thereof having a normal boiling point less than 25° C., the gaseous stream passing through said polymerization zone with an upward velocity sufficient to maintain said particles in a suspended and gas fluidized condition;
(2) introducing a polymerization catalyst into said polymerization zone;
(3) withdrawing polymer product from said polymerization zone;
(4) continuously withdrawing a stream of unreacted gases comprising the at least one monomer and the material from said polymerization zone, compressing and cooling said stream to a temperature below the dew point of said stream to form a two-phase fluid mixture comprising a gas phase and a liquid phase; and
(5) continuously introducing said two-phase fluid mixture into said polymerization zone wherein said liquid phase is vaporized.

21. A method for controlling the temperature of a fluidized bed during the production of polymers in a gas fluidized bed reactor by an exothermic polymerization reaction which comprises continuously introducing a stream comprising at least one monomer and at least one alkane having a normal boiling temperature less than 25° C., the gas-liquid mixture introduced into said bed wherein said liquid is vaporized.

22. A process for producing a polymer from a monomer by an exothermic polymerization reaction in a gas fluidized bed reactor, which comprises:
(1) continuously passing a gaseous stream comprising the monomer and an alkane having a normal boiling point less than 25° C., the gaseous stream passing through said polymerization zone with an upward velocity sufficient to maintain said particles in a suspended and gas fluidized condition;
(2) introducing a polymerization catalyst into said polymerization zone;
(3) withdrawing polymer product from said polymerization zone;
(4) continuously withdrawing a stream of unreacted gases comprising the monomer and the alkane from said polymerization zone, compressing and cooling said stream to a temperature below the dew point of said stream to form a mixture comprising a gas phase and a liquid phase;
(5) continuously introducing said mixture into said polymerization zone wherein said liquid phase is vaporized; and
(6) controlling the temperature of said mixture so as to maintain a substantially constant temperature in said polymerization zone, as the change in at least one of the polymerization catalyst feed rate and the feed rate of said mixture are varied to control the rate of said polymerization.

23. An induced condensing agent comprising a material selected from the group consisting of alkanes, cycloalkanes, and mixtures thereof, the induced condensing agent having a normal boiling point less than 25° C.

24. The induced condensing agent of claim 23, wherein the induced condensing agent has a normal boiling point less than 10° C.

26. The induced condensing agent of claim 23, wherein the material comprises n-butane.

27. The induced condensing agent of claim 23, wherein the material comprises iso-butane.

28. The induced condensing agent of claim 23, wherein the material comprises propane.

29. The induced condensing agent of claim 23, wherein the material comprises cyclopropane.

30. The induced condensing agent of claim 23, wherein the material comprises cyclobutane
